(19) United States
(12) Patent Application Publication
(10) Pub. No.: US 2013/0179252 A1
(43) Pub. Date: Jul. 11, 2013

(54) METHOD OR SYSTEM FOR CONTENT RECOMMENDATIONS

(71) Applicants: Anlei Dong, Fremont, CA (US); Jiang Bian, Atlanta, GA (US); Xiaofeng He, Chengdu (CN); Srihari Reddy, Santa Clara, CA (US); Yi Chang, Sunnyvale, CA (US)

(72) Inventors: Anlei Dong, Fremont, CA (US); Jiang Bian, Atlanta, GA (US); Xiaofeng He, Chengdu (CN); Srihari Reddy, Santa Clara, CA (US); Yi Chang, Sunnyvale, CA (US)

(73) Assignee: Yahoo! Inc., Sunnyvale, CA (US)

(21) Appl. No.: 13/348,573

(22) Filed: Jan. 11, 2012

(51) Int. Cl. G06Q 30/02; G06F 15/18; G06N 5/04

(52) U.S. Cl. 705/14.43; 706/45; 706/12

(57) ABSTRACT

Methods and systems are provided that may be utilized to recommend content to a user.

### BACKGROUND

1. Field

The subject matter disclosed herein relates to a method or system for recommending content to user other than for or via a search engine recommendation.

2. Information

Some media networks, such as Internet media networks, may comprise a large number of registered users and links to media content, such as news, articles, etc. For example, the Yahoo!™ network comprises over half a billion users and quality media assets, such as those in the realm of news, sports and finance, to name just a few among different examples of media assets.

Media networks strive to encourage users to remain within a particular network or website as such users may be valuable to various advertising entities. For example, the more users which view a particular financial section or website within a media network, the more valuable that financial section or website may become and the more money that potential advertisers may be willing to pay to advertise to such users. Accordingly, given a broad range of users and news articles or other media content available within a media network, a value of the media network may potentially be increased if relevant media content is provided to users to encourage remaining within the media network for an extended period of time.

### BRIEF DESCRIPTION OF DRAWINGS

Non-limiting and non-exhaustive aspects are described with reference to the following figures, wherein like reference numerals refer to like parts throughout the various figures unless otherwise specified.

FIG. 1 is screen capture of an example home portal web page;

FIG. 2 is a plot illustrating position bias and click through rate;

FIG. 3 is a flow chart of a method for content recommendations in accordance with an embodiment;

FIG. 4 is a schematic diagram illustrating a computing system environment system in accordance with an embodiment.

### DETAILED DESCRIPTION

Reference throughout this specification to “one example,” “one feature,” “one embodiment,” “an example,” “a feature,” or “an embodiment” means that a particular feature, structure, or characteristic described in connection with the feature, example or embodiment is included in at least one feature, example or embodiment of claimed subject matter. Thus, appearances of the phrase “in one example,” “an example,” “in one feature,” a feature,” “an embodiment,” or “in one embodiment” in various places throughout this specification are not necessarily all referring to the same feature, example, or embodiment. Furthermore, particular features, structures, or characteristics may be combined in one or more examples, features, or embodiments.

Media networks, such as the Yahoo!™ network, for example, are increasingly seeking ways to keep users within their networks. A media network may comprise an Internet website or group of websites having one or more sections, for example. For example, the Yahoo!™ network includes websites located within different categorized sections such as sports, finance, news, and games, to name just a few among possible non-limiting examples. A media network may comprise an Internet-based network or a non-Internet based network, for example.

The more users who remain within a media network for an extended period of time, the more valuable a network may become to potential advertisers and the more money advertisers may pay to advertise to users, for example. In an implementation, as discussed below, content selection by users of a media network and media content available within a network may be used to provide recommendations for relevant content to entice users to remain within a network, such as for a relatively extended period of time. Recommendations for content, such as on websites located outside of a media network, may also be presented to users. For example, even if users are directed to websites outside of a particular media network, users may, in effect, remain loyal to the media network in the future if they believe that the media network provides links to highly relevant or interesting content.

According to one or more implementations, as discussed herein, a system or method may be provided for determining or presenting recommendations for content for one or more users, such as of a media network. A personalized recommendation approach may be provided to predict users' responses to media content items, such as user selections, views or clicks. In other words, recommendations may be based on a likelihood or probability that a user will select or click on or otherwise become engaged in some way with one or more content items.

An approach may be utilized to predict user selection, browsing or click behavior for a group of users, as an example. Recommendations for content may be determined based at least in part on user segmentation using real-time online learning, for example. Moreover, a personalized approach may be employed.

A “user,” as used herein may refer to an individual for which one or more characteristics are known or estimated, for example. A user may be registered within a particular media network, for example. A user may be identified based at least in part on an identifier, such as a user name, or cookies or other identifier associated with the user and which may be stored on the user's computer, for example. A user may be associated with a user profile which may associate the user with demographic or background information, location, age, user preferences, or other attributes, for example. “Content,” as used herein may refer to media content or one or more links to media content. Content may comprise one or more websites, text files, applications, audio files, video files, as well as other forms of content, for example. Interactions between users of a media network, available content, and related information with respect to users or content may be utilized in one or more embodiments, as described in more detail below.

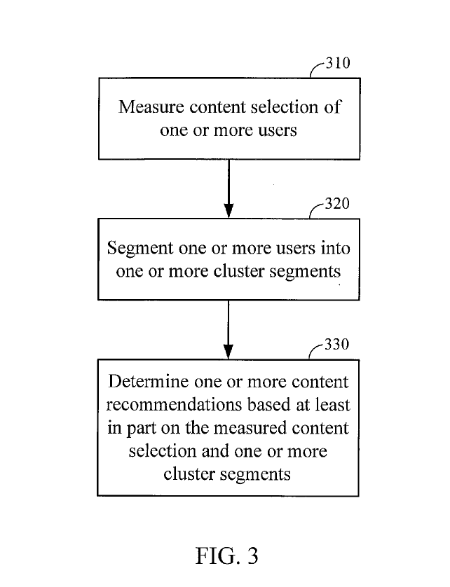

FIG. 3 is an example embodiment of a method of determining one or more content recommendations. For example, in embodiment 300, determining one or more content recommendations other than for a search engine recommendation may include the following. As shown by block 310, content selection of one or more users may be measured. Likewise, as shown by block 320, one or more users may be segmented into one or more cluster segments of a plurality of clusters based at least in part on the measured content selection. Further, as shown by block 330, one or more content recommendations for one or more users may be determined from a set of content items based at least in part on the measured content selection and one or more cluster segments. Of course, this is one illustration of an example embodiment and claimed subject matter is not limited to a particular illustrative embodiment. Nonetheless, this and other embodiments shall be described in more detail below and throughout this document.

User interaction may play a role in content retrieval applications including recommender systems. Typically, implicit user interactions with recommended items or explicit user ratings on items may provide a basis for training models; however, user interaction in real-world applications (e.g., a portal website with different recommendation modules in the interface) are unlikely as ideal as may be assumed. Opportunities for improvement in this regard in one or more embodiments may include, for example: 1) use of users' behaviors for user segmentation to assist in generate personalized recommendations that may produce a higher click through rate (CTR); 2) use of user engagement factors such as user's historic activity, position bias effect, etc., to improve the quality of real-time learning.

Recent years have witnessed many studies on content systems on the web. For example, portal websites (e.g., www.msn.com, www.yahoo.com, www.aol.com) desire to present to visitors with interesting and/or quality content of different types like videos, images, news articles, topics etc. to attract more visitors and/or improve user engagement, as suggested previously. However, content recommendation processes have generally focused on content ranking to improve engagement metrics like click through rates or other user satisfaction metrics. In these applications, the problems are abstracted as a predicted user response on an inventory of content items. In practice, however, these applications individually may comprise just one part of many on a densely packed interface. Items in one application may therefore competing for user interest, such as with the following examples:

1. Items within the same application. E.g. other news articles in a module, for example, that shows news articles.

2. other applications showing different types of content on the webpage. E.g. news articles in a news article module may competing with videos in a top videos application.

3. links on a web page for users regularly visiting the web page. E.g. search box for web search, link to applications like e-mail, instant messenger, games etc.

In web applications like a portal site which may, for example, attract millions of page views in a few hours, sizable distractions of different kinds may be present, such as described above. As a result, the quality of signals available with respect to content selection choices may have large variations making delivering quality personalized recommendations a challenge. However, advances regarding how to interpret user action and characterize different groups of users may improve user behavior prediction for making content recommendations. How users interact with content and/or differences compared with web search, for example, using content selection, such as clicks and/or skips and/or other indications, may provide recommendation improvements in some embodiments. For example, one or more embodiments may include aspects in accordance with these general themes:

1. User segmentation may be employed. Variations exist in groups users who consume content. On a typical portal page, for example, regular users may visit the page to access a specific service like e-mail, other users may visit the page to access specific content, such as modules like news, and still other users may visit the page to access a specific application and/or find something else of interest.

2. Adjustments may be made to at least partially account for position bias in user content selection. Likewise, differences in position bias and effects may exist between a query driven, relevancy based ranking and/or query-less content ranking.

3. Sample weighting may be employed based at least in part on user action type. Not all clicks reflect the same amount of user attention or engagement. In web search, rank of a clicked document and/or duration of time spent on a clicked document are useful signals in improving ranking. In content ranking which is query less, duration between page view and click time stamp, for example, may be useful in prediction.

Empirical results indicate embodiments that include aspects along these themes may improve user engagement metrics by over 20%. Furthermore, these improvements may be observed on small user segments suggesting some effectiveness in connection with personalized recommendations.

Embodiments of a content recommendation system may, for example, use dynamic click through rate (CTR) tracking for estimation in connection with a personalization approach based at least in part on user population segmentation. Various user segmentation approaches for personalization are described as illustrative examples, such as using pre-defined user attributes, user's previous interactions and/or a tensor approach that combines user attributes with item attributes. Of course, claimed subject matter is not intended to be limited in scope to illustrative examples. Likewise, in some embodiments, interpreting different user actions may also be employed, such as, for example, heavy and light users being handled differently and/or adjusting at least in part for the effect of position bias. Again, claimed subject matter is not limited to illustrative examples or embodiments.

Embodiments of content recommendation through a personalization approach may be employed with respect to any one of a host of possible objectives. For example, in one embodiment, an objective may be to improve overall click-through rate (CTR). Another objective may comprise improving revenue, such as advertising revenue. Since different advertisers may compensate according to a variety of approaches, that latter objective may be more complex. Likewise, approaches may be extended to tasks with different objectives as well without loss of generality. Typically, a recommender system embodiment may include a capability to collect large amount of user interactive samples. A typical example includes a portal homepage, which may attract many visitors to browse and/or click. In an embodiment estimate, to estimate candidate item attractiveness, an online learning approach may, for example, continually collect users' interactive feedback samples or sample values to improve recommendation results over time.

An embodiment employing a personalization approach may provide users with a personalized experience of relevant and/or interesting content, so that user engagement, conversions and/or long-term loyalty may be improved. A divide-and-conquer approach for an embodiment may assist in achieving personalization. In an embodiment, for example, users may be divided into a few different groups based at least in part on user profiles. For a group of users, for example, a system embodiment may serve or recommend content updated using feedback samples provided by the users belonging to the group. As indicated previously, in this context, this may be referred to as user segmentation. For an embodiment of a user-segmentation-type personalization system, two relevant technical issues include the following:

1) How to appropriately divide users into different groups?

2) Within a group, how to utilize user feedback samples to achieve effective online learning?

In one embodiment, a criterion may comprise that homogeneous users (e.g., users with similar interests, characteristics, behaviors, etc) belong to the same group, while heterogeneous users belong to different groups. An embodiment may heuristically achieve reasonable user grouping; likewise, however, an alternative may employ a process that considers behavior actions also or in addition to generate groups or cluster segments. Samples or sample values for online learning may be obtained from user feedback actions, for example.

For user segmentation approach, as learning samples may be more sparse for separate cluster segments, a better or improved understanding of user actions may be more desirable. User action interpretation may therefore affect the two issues mentioned above. Two illustrative examples of a user-action-type user segmentation approach are described; however, these provide off-line learning approaches, specifically.

For a content item, CTR may typically show temporal variation. For example, attractiveness of an item may change over time and/or may be affected by other items served to users. Therefore, a dynamic CTR measurement may be employed in some embodiments. Likewise, an embodiment may comprise a per-item implementation. For example, for a content item, its dynamic CTR may be measured in real-time or approximately real-time in an embodiment. For example, as a homepage for a portal, for example, attracts hundreds of millions of user visits per day, a large amount of feedback samples (e.g., clicks and/or views) may be obtained and used to measure CTR in near-real-time mode. More specifically, in an embodiment, an estimate of CTR values of items in a candidate pool may be determined by aggregating selections, such as clicks and/or views, reasonably frequently, for example, and update an item ranking by dynamic CTR estimation scores.

An embodiment may also employ a random learning bucket. For example, if a user visits a portal homepage, the visit may be randomly selected for a random learning bucket or other serving buckets. Within a random learning bucket, items in a candidate pool may be randomly or pseudo-randomly selected and served for a visit. In an embodiment, a random learning bucket may occupy a small fraction of homepage traffic. Therefore, the probability that visit falls into random learning bucket may be small and have little or negligible affect on overall performance. However, a random learning bucket may assist in estimating item dynamic CTR. An advantage of a random bucket implementation it that items have substantially equal chances to be served to users. To estimate CTR from users' feedback samples may be computationally less complex since adjustment for bias, such as position bias, or that some items do not have enough opportunities to be explored, may be omitted.

For visits outside a random learning bucket, an embodiment may serve users with items having relatively high dynamic CTR estimations. In one possible embodiment, a Gamma-Poisson distribution may be used to estimate dynamic CTR, although, of course, claimed subject matter is not limited in scope to a Gamma-Poisson distribution. A host of possible distributions may be employed, such as Gaussian, Markov, etc. to name just a few out of possibilities. However, computationally, a Gamma-Poisson distribution may be relatively easy to implement for an embodiment.

For an item in random learning bucket, let pt be its CTR at time t, nt be the number of times a content item is shown to users (e.g., user impressions) and, ct be the number of clicks or selections that are resulted from these nt impressions. Assume CTR does not change much over time or is reasonably stationary so the t index in pt may be dropped. The Gamma-Poisson approach assumes:

cₜ˜Poisson(pnₜ), (1)

p˜Gamma(mean=μ, size=γ), (2)

where μ comprises CTR according to a prior belief, and γ is the equivalent sample size of the prior belief. A Gamma-Poisson model provides “smoothed” count, which estimates p as

$${p}_{t} = \frac{( γ μ + {\sum }_{τ < t} {c}_{τ} )}{( γ + {\sum }_{τ < t} {n}_{τ} )} . \qquad ( 3 )$$

For user segmentation, site visitor's interests, consumption history and/or other descriptions may be collected in an embodiment. A variety of user profiling techniques are reviewed in: Billsus and Pazzani, Adaptive News Access, in “The Adaptive Web—Methods and Strategies of Web Personalization”, 2007. There are common approaches, such as explicit or implicit profiling. In explicit profiling, a site may request a visitor to provide demographics explicitly such as age, gender, occupation, preferences, etc. In implicit profiling, a site may track visitors' behavior. For example, viewing, browsing and for purchasing patterns may be accessed. A profile containing demographic, transaction and/or navigation samples implicitly may capture a user's preferences and/or recent interests. if therefore a user is represented as a vector in feature space, the feature space may be spanned by usable user profiles.

For one embodiment of a user segmentation approach, homogeneous groups of users may be entailed by a priori segmentation, such as described, for example, in Y. Wind, “Issues and Advances in Segmentation Research,” Journal of Marketing Research, 1978. Further, a segment or cluster segment of users may be served with a dedicated recommender. There are a few other categories of personalization approaches for recommendation systems; however, user segmentation approach has advantages of simplicity and/or reliability, useful, for example, for real-world product implementation.

A criterion for user segmentation in an embodiment may comprise grouping homogeneous users (e.g., users with similar interests, characteristics, behaviors, etc.) into the same segment while aggregating or grouping heterogeneous users into different ones. One method comprises grouping users based at least in part on demographics. However, heuristic rules may be ad hoc and may omit user behavior, although user behavior may better reflect users' interests. However, one or more embodiments may utilize rich user behavior samples, especially histories of users' clicks on a front page portal, to build a user segmentation to better serving recommendations. To illustrate, we introduce two different approaches, although many others are possible and included within the scope of claimed subject matter.

Users with corresponding demographic features, such as age and/or gender, are more likely to have similar interests. Accordingly, a reasonable approach for user segmentation includes grouping users based at least in part on combinations of several demographic features provided by users themselves. As an illustrative example using age and gender and one may group users into 7 segments, as illustrated in Table 1, below

TABLE 1
User segmentation based on demographic features
Segment Age Range and Gender

f-u20 10 < age <= 20, gender = female
f-u40 20 < age <= 40, gender = female
f-u80 40 < age <= 80, gender = female
m-u20 10 < age <= 20, gender = male
m-u40 20 < age <= 40, gender = male
m-u80 40 < age <= 80, gender = male
unk unknown age or gender

A heuristic segmentation approach such as with demographics is simple and easy-to-implement, however, risks include: demographic samples may be noisy or unreal; and segmentation may not be fine-grained enough for reasonably effective segmentation. As alluded to, another indication for users' interests may comprise user behavior samples, which may be employed to build a user segmentation so as to better serve content recommendations, for example.

As a result of users surfing the Web, plenty of samples of users behaviors or actions on content displayed is available. Although interactions between users and content may vary depending at least in part on the types of content items involved, it may be possible to observe or generalize some behavioral patterns. From a on log of users' actions on portal homepage, such as Yahoo!, for example, we can extract more than 1000 binary features describing users' behavior patterns in one possible approach. Rich user behavior samples of actions can provide explicit signals for indicating users' interests so as to benefit performance of an embodiment of a personalized recommender system.

Users with similar behavior patterns are more likely to have the similar interests. Thus, a feature vector may be constructed for users by using those binary features. However, for improved efficiency, due to the large amount of binary features, it may be possible reduce the dimension of user features by doing feature selection. In one embodiment, a method comprises selecting features based on “support”, which means the number of samples having the feature. For example, features of support above a threshold, e.g. 5% of the population, are selected in an example embodiment.

In another embodiment, however, another feature selection method may comprise utilizing users' click behavior on a module served by a recommender system. In particular, in an embodiment, an approach may select a set of items which have been clicked by users in a particular content module during a certain period. A feature vector of items may be generated by aggregating feature vectors of users who ever clicked an item in the certain period. After that, normalization of the feature vector across different items may permit selecting those feature dimensions whose respective normalized value is above a threshold. An advantage of this latter selection method may be that samples of users who have more engagement on the content module are captured in comparison with a larger set of users.

After selecting a set of features, users may be represented in the feature space and an unsupervised clustering method may be used to accomplish user segmentation, e.g. K-means clustering, for example, may be used. The clustering output will form segmentation for users by cluster segment.

A more sophisticated approach, referred to as tensor segmentation, may be employed. See, for example, Chu, Park, Beaupre, Motgi and Phadke, “A case study of behavior drive conjoint analysis on yahoo! Front page today module”, Proc. Of KDD, 2009. It has demonstrated effectiveness for conjoint analysis, which is a method in market research to measure how customers with different preference value different features of a product or service. Since tensor segmentation comprises a scalable conjoint analysis technique to learn user preference in the presence of features and product characteristics, by viewing content items as a product in conjoint analysis, a similar technique may be used to accomplish user segmentation.

A user may be denoted as a user feature vector xᵢ, a content item as an item feature vector zⱼ. A tensor product of xᵢ and zⱼ comprises:

$${s}_{ij} = {\sum }_{a}^{\vert {z}_{j} \vert} {{\sum }_{b}}^{\vert {z}_{i} \vert} {w}_{ab} {x}_{i , b} {z}_{j , a} .$$

This may be simplified as vector matrix multiplication as:

sᵢⱼ=xᵢ^{T}Wzⱼ,

where W comprises a matrix of appropriate dimensions. This may be referred to as a bilinear formulation and has been studied elsewhere. sᵢⱼ represents an indicator related to a response rᵢⱼ of user xᵢ on content zⱼ by logistic regression as

$$p ( {r}_{ij} \vert {s}_{ij} ) = \frac{1}{1 + exp ( - {r}_{ij} {s}_{ij} + ι )}$$

where i is a global offset. A user-specific bias μᵢ and query-specific bias γⱼ may be introduced to transform tensor indicator sᵢⱼ into

s_{îj}=sᵢⱼ−μᵢ−γⱼ.

The matrix W may be computing using logistic regression problem. After matrix W is available, user x may be projected to feature space as W^{T}x, a vector with length of |z^{j}|.

In the feature space, clustering may be used with the vectors in feature space to obtain user clusters or cluster segments. Again, a K-means process may be used on transformed user feature vectors to generate user clusters, although other approaches to clustering may also be employed.

As discussed, user interactive feedback samples may be employed in some embodiments to facilitate generating a recommendation result. For a candidate item, its CTR may be estimated based at least in part on number of clicks and/or views. Therefore, interpretation of user actions of click/view samples derived from a log of user actions may affect results. Along this direction, an embodiment may further account for user engagement and/or position bias.

As discussed previously, different applications may compete with each other on a densely packed interface, such as the front page of a portal site. If a user visits a web site, an event may be logged as a sample such as user ID, time stamp, content viewed/clicked by the user, etc. However, such an event may not necessarily mean the user is really engaged in content displayed. Here, engagement means the user examined or at least partly examined recommended contents. For example, it is possible she totally ignores module content as she may be attracted by the contents of other modules, or she goes for other services such as search and/or e-mail. For a recommendation module, accurate CTR estimation should be based on events where users were really engaged, instead of all events where contents was displayed. Therefore, for at least some embodiments, a systematic way may be employed to automatically estimate user engagement. For an embodiment, three categories of events regarding user engagement may, for example, be identified:

1.Click event: A click event refers to an event where a user clicked one or more items in a module, such as a content recommendation module, after she opened a web page. In a click event, it may be inferred that the user is engaged in the module because she examined at least some items recommended by the module.

2. Click-other event: A click-other event, refers to at least one action on another application/module in the interface (such as clicking items displayed by other modules, doing search in search box, etc).

3. Non-click event: Besides click events and clicks-other events, there are also non-click events in which users had no specific action, such as click or search, after they opened the web page. For a non-click event, unlike click event or click-other event, it may be a challenge to determine whether or not the user actually examined the content recommendation module. However, based at least in part on previous behaviors, it still may be possible to deduce or infer if the user intends to examine the module or not. If a user often clicked the module in the past, it implies this user is interested in the module so that it may be likely she actually examined the module in the latest recent event. For a user, for example, we can check the number of clicks on the module during a specified length of past period and use such click number to present a probability that this user actually examined the module in the most recent event.

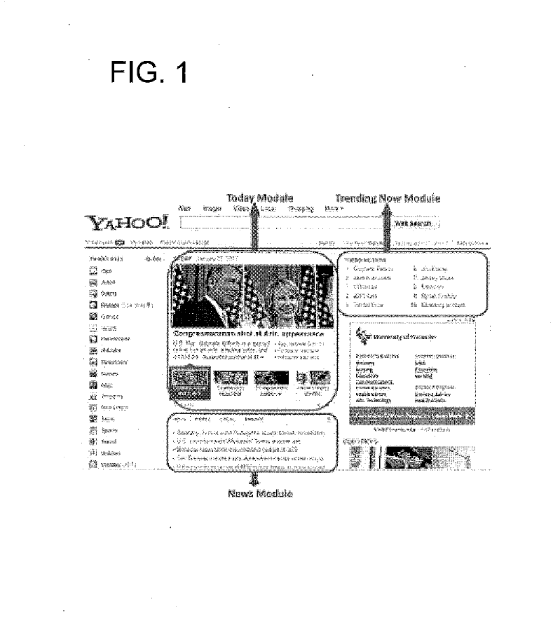

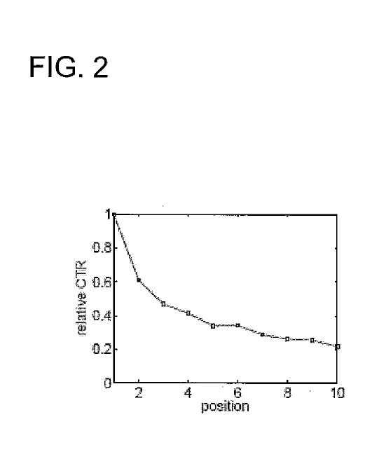

However, even for a user engaged in a recommendation module, she may only partly examine recommended items. In the example of Yahoo! Trending Now module, shown in FIG. 1, for example, there are ten busy queries that are displayed. If an item is displayed at different positions, the probabilities that it will be clicked are different. FIG. 2 is a plot 2 that illustrates such position bias effect fro random learning bucket samples in one month. Average CTR values were computed for at different positions. The figure shows relative CTR values, which are obtained by dividing CTR values with the CTR value at position 1. With position moving from top to bottom (Position 1, 2, 3, . . . , 10), the CTR values drops monotonously. As previously discussed, candidate queries in the random learning bucket are randomly displayed at any position. Therefore, the CTR variation at different positions reflects the fact that an item's click probabilities are affected by position. Factors that may lead to position bias include: an item displayed at different positions may have different chances to be examined by users; for an item is displayed at bottom positions, users may have less confidence that this item has high quality. This position bias may be referred to as position decay factor. More specifically, for an item that is displayed to the user at Position j, the probability that it is clicked prob(clicked|pos=j) is:

αⱼprob(exam|pos=j)prob(clicked|exam),

where prob(clicked|exam) is the probability that the item is clicked if it is examined by the user, prob(exam|pos=j) is the probability that the item is examined by the user if it is displayed at Position j and αⱼ is the position decay factor. The relation may be rewritten as:

prob(clicked|pos=j)=βⱼprob(clicked|exam),

so that βⱼ is position related. Typically, the closer to the bottom of the position, the lower the value, as FIG. 2 illustrates.

Recall from an embodiment in which a Poisson distribution was employed. For different positions, Poisson parameters are different for the same item. This leads to this following relation in which i and j represent different positions:

$$\frac{{p}_{i}}{{p}_{j}} = \frac{{β}_{i}}{{β}_{j}} .$$

For an item, in an embodiment, an approach may be to aggregate its clicks/views at available positions for CTR estimation; for example, the samples at a single position may not be enough for reliable estimation. To adjust at least partially for bias in click/view aggregation for CTR estimation, for the clicks and views at Position j, for example, the ratio above allows us to adjust through multiplication or division as appropriate. This is consistent with the intuition that if a click happens at bottom position, this click should be over weighted, or views of non-clicked items should be discounted. In an embodiment, for example, a period of samples may be accumulated for a random learning bucket, similar to FIG. 2, with average CTR computed at various positions to compute:

$$\frac{{β}_{j}}{{β}_{1 }} = \frac{\overline{{CTR}_{j}}}{\overline{{CTR}_{1}}} .$$

In an example embodiment, a server or server system may be in communication with client resources, such as a computing platform, via a communication network. A communication network may comprise one or more wireless or wired networks, or any combination thereof. Examples of communication networks may include, but are not limited to, a Wi-Fi network, a Wi-MAX network, the Internet, the web, a local area network (LAN), a wide area network (WAN), a telephone network, or any combination thereof, etc.

A server or server system, for example, may operatively be coupled to network resources or to a communications network, for example. An end user, for example, may communicate with a server system, such as via a communications network, using, e.g., client resources, such as a computing platform. For example, a user may wish to access one or more content items, such as related to a category of objects.

For instance, for example, a user may send a content request. A request may be transmitted using client resources, such as a computing platform, as signals via a communications network. Client resources, for example, may comprise a personal computer or other portable device (e.g., a laptop, a desktop, a netbook, a tablet or slate computer, etc.), a personal digital assistant (PDA), a so-called smart phone with access to the Internet, a gaming machine (e.g., a console, a hand-held, etc.), a mobile communication device, an entertainment appliance (e.g., a television, a set-top box, an e-book reader, etc.), or any combination thereof, etc., just to name a few examples. A server or server system may receive, via a communications network, signals representing a request that relates to a content item. A server or server system may initiate transmission of signals to provide content related suggestions or recommendations, for example.

Client resources may include a browser. A browser may be utilized to, e.g., view or otherwise access content, such as, from the Internet, for example. A browser may comprise a standalone application, or an application that is embedded in or forms at least part of another program or operating system, etc. Client resources may also include or present a graphical user interface. An interface, such as GUI, may include, for example, an electronic display screen or various input or output devices. Input devices may include, for example, a microphone, a mouse, a keyboard, a pointing device, a touch screen, a gesture recognition system (e.g., a camera or other sensor), or any combinations thereof, etc., just to name a few examples. Output devices may include, for example, a display screen, speakers, tactile feedback/output systems, or any combination thereof, etc., just to name a few examples. In an example embodiment, a user may submit a request for content via an interface, although claimed subject matter is not limited in scope in this respect. Signals may be transmitted via client resources to a server system via a communications network, for example. A variety of approaches are possible and claimed subject matter is intended to cover such approaches.

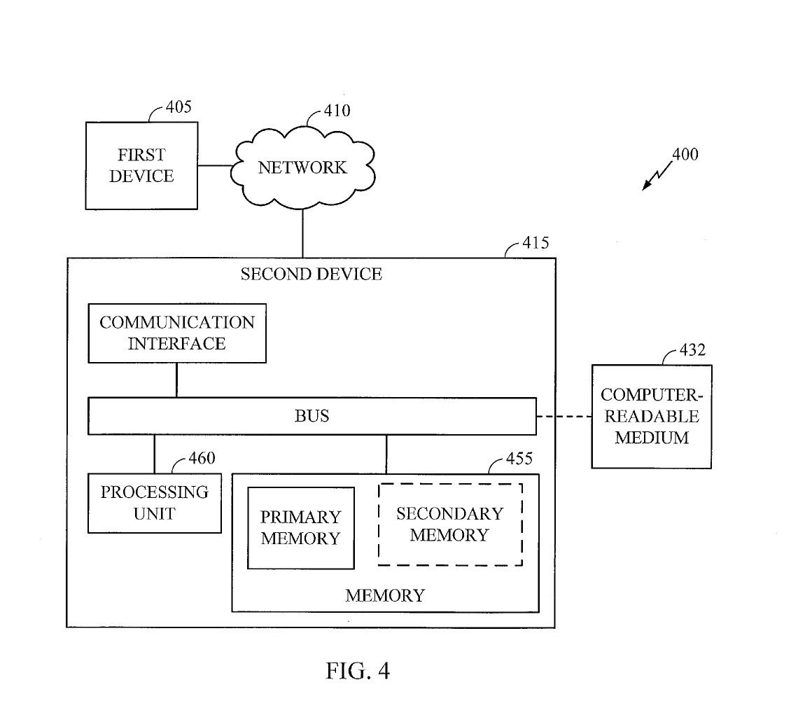

FIG. 4 is a schematic diagram of a system 400 that may include a server 405, a network 410, and a user computing platform 415. Server 405 may jointly process samples about users and may determine content recommendations for one or more users, as discussed above. Although only one server 405 is shown in FIG. 4, it should be appreciated that multiple servers may perform such joint processing. Server 405 may include a transmitter 420, receiver 425, processor 430, and memory 435.

In one or more implementations, a modem or other communication device capable of transmitting and/or receiving electronic signals may be utilized instead of or in addition to transmitter 420 and/or receiver 425. Transmitter 420 may transmit one or more electronic signals containing content recommendations to computing platform 415 via network 410. Receiver 425 may receive one or more electronic signals which may contain samples, states or signals relating to users and/or content, for example.

Processor 430 may be representative of one or more circuits, such as digital circuits, to perform at least a portion of a computing procedure or process. By way of example but not limitation, processor 430 may include one or more processors, controllers, microprocessors, microcontrollers, application specific integrated circuits, digital signal processors, programmable logic devices, field programmable gate arrays, and the like, or any combination thereof.

Memory 435 is representative of any storage mechanism. Memory 435 may include, for example, a primary memory or a secondary memory. Memory 435 may include, for example, a random access memory, read only memory, or one or more data storage devices or systems, such as, for example, a disk drive, an optical disc drive, a tape drive, a solid state memory drive, to name just a few examples. Memory 435 may be utilized to store state or signal information relating to users and/or content, for example. Memory 435 may comprise a computer-readable medium that may carry and/or make accessible content, code and/or instructions, for example, executable by processor 430 or some other controller or processor capable of executing instructions, for example.

Network 410 may comprise one or more communication links, processes, and/or resources to support exchanging communication signals between server 405 and user computing platform 415. By way of example but not limitation, network 410 may include wireless and/or wired communication links, telephone or telecommunications systems, data buses or channels, optical fibers, terrestrial or satellite resources, local area networks, wide area networks, intranets, the Internet, routers or switches, and the like, or any combination thereof.

A computing platform 415 may comprise one or more computing devices and/or platforms, such as, e.g., a desktop computer, a laptop computer, a workstation, a server device, or the like; one or more personal computing or communication devices or appliances, such as, e.g., a personal digital assistant, mobile communication device, or the like; a computing system and/or associated service provider capability, such as, e.g., a database or data storage service provider/system, a network service provider/system, an Internet or intranet service provider/system, a portal and/or search engine service provider/system, a wireless communication service provider/system; and/or any combination thereof.

A computing platform 415 may include items such as transmitter 440, receiver 445, display 450, memory 455, processor 460, or user input device 465. In one or more implementations, a modem or other communication device capable of transmitting and/or receiving electronic signals may be utilized instead of or in addition to transmitter 440 and/or receiver 445. Transmitter 440 may transmit one or more electronic signals to server 405 via network 410. Receiver 445 may receive one or more electronic signals which may contain content recommendations, for example. Display 450 may comprise an output device capable of displaying visual signals or states, such as a computer monitor, cathode ray tube, LCD, plasma screen, and so forth.

Memory 455 may store cookies relating to one or more users and may also comprise a computer-readable medium that may carry and/or make accessible content, code and/or instructions, for example, executable by processor 460 or some other controller or processor capable of executing instructions, for example. User input device 465 may comprise a computer mouse, stylus, track ball, keyboard, or any other device capable of receiving an input, such as from a user.

Some portions of the detailed description which follow are presented in terms of algorithms or symbolic representations of operations on binary digital signals or states, such as stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and generally, considered to be a self-consistent sequence of operations or similar signal processing leading to a desired result. In this context, operations or processing involves physical manipulation of physical quantities. Typically, although not necessarily, physical quantities may take the form of electrical or magnetic signals capable of being stored, transferred, combined, compared or otherwise manipulated.

It has proven convenient at times, principally for reasons of common usage, to refer to physical signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals or states, typically represented as physical electronic or magnetic quantities within memories, registers, or other information storage devices, transmission devices, or display devices of the special purpose computer or similar special purpose electronic computing device.

While certain example techniques have been described and shown herein using various methods and systems, it should be understood by those skilled in the art that various other modifications may be made and/or equivalents may be substituted, without departing from claimed subject matter. Additionally, many modifications may be made to adapt a particular situation to the teachings of claimed subject matter without departing from one or more central concepts described herein. Therefore, it is intended that claimed subject matter not be limited to the particular examples disclosed, but that such claimed subject matter may also include all implementations falling or covered by any of the appended claims, and/or equivalents thereof.

1. A method of determining one or more content recommendations other than for a search engine recommendation comprising:
measuring content selection of one or more users;
segmenting said one or more users into one or more cluster segments of a plurality of clusters based at least in part on the measured content selection; and
determining said one or more content recommendations for said one or more users from a set of content items based at least in part on the measured content selection and said one or more cluster segments.

2. The method of claim 1, wherein said determining comprises determining said one or more content recommendations to improve click through rate (CTR).

3. The method of claim 1, wherein said determining comprises determining said one or more content recommendations to improve generated advertising revenue.

4. The method of claim 1, said measuring content selection of one or more users comprises online real-time learning; and wherein said determining comprises determining said one or more content recommendations based at least in part on said online real-time learning.

5. The method of claim 4, wherein said online real-time learning comprises online real-time learning for said one or more cluster segments; and wherein said determining comprises determining said one or more content recommendations based at least in part on said online real-time learning for said one or more cluster segments.

6. The method of claim 5, wherein said online real-time learning for said one or more cluster segments comprises measuring dynamic CTR.

7. The method of claim 6, wherein measuring dynamic CTR comprises measuring approximately real-time users of said one or more cluster segments selecting a hyperlink to specified online content.

8. The method of claim 1, wherein segmenting said one or more users includes segmentation into a cluster of pseudo-randomly selected users.

9. The method of claim 1, wherein said measuring content selection of one or more users further comprises measuring user engagement.

10. The method of claim 9, wherein said measuring user engagement comprises measuring at least one of the following: specific user action or specific user inaction.

11. The method of claim 10, wherein measuring specific user action comprises measuring at least one of the following: selecting a hyperlink to specific content or user action other than selecting a hyperlink to specific content.

12. The method of claim 1, wherein said segmenting comprises segmenting users based at least in part on k means clustering or based at least in part on tensor segmentation.

13. The method of claim 1, wherein said measuring content selection of one or more users further comprises adjusting for position bias.

14. An apparatus comprising: a computing platform; said computing platform to: measure content selection of one or more users, segment said one or more users into one or more cluster segments of a plurality of clusters based at least in part on the measured content selection, and determine said one or more content recommendations for said one or more users from a set of content items based at least in part on the measured content selection and said one or more cluster segments.

15. The apparatus of claim 14, wherein said computing platform to measure content selection of one or more users comprise a computing platform to further measure user engagement.

16. The apparatus of claim 15, wherein said computing platform to measure user engagement comprises a computing platform to further measure at least one of the following: specific user action or specific user inaction.

17. The apparatus of claim 16, wherein said computing platform to measure specific user action comprises a computing platform to further measure at least one of the following: selecting a hyperlink to specific content or user action other than selecting a hyperlink to specific content.

18. An article comprising: a storage medium having stored thereon instructions capable of being executed by a computing platform to: measure content selection of one or more users, segment said one or more users into one or more cluster segments of a plurality of clusters based at least in part on the measured content selection, and determine said one or more content recommendations for said one or more users from a set of content items based at least in part on the measured content selection and said one or more cluster segments.

19. The article of claim 18, wherein said instructions capable of being executed to measure content selection of one or more users further comprise instructions to measure user engagement.

20. The article of claim 19, wherein said instructions capable of being exectued to measure user engagement further comprise instructions to measure at least one of the following: selecting a hyperlink to specific content or user action other than selecting a hyperlink to specific content.
